(19) United States
(12) Patent Application Publication
(10) Pub. No.: US 2009/0026036 A1
(43) Pub. Date: Jan. 29, 2009

(54) DISC CARRIER OF A FRICTION CLUTCH

(76) Inventors: Ahmed Sayhoun, Weilheim (DE); Falk Nickel, Fuchstal (DE); Georg Ruprecht, Biessenhofen (DE)

Correspondence Address: MICHAEL BEST & FRIEDRICH LLP, 100 E WISCONSIN AVENUE, Suite 3300, MILWAUKEE, WI, 53202, US

(21) Appl. No.: 12/181,113

(22) Filed: Jul. 28, 2008

(30) Foreign Application Priority Data
Jul. 26, 2007 (EP) 07014701.2

(51) Int. Cl. F16D 11/00; F16D 69/00

(52) U.S. Cl. 192/53.1; 192/200

(57) ABSTRACT

The present invention according to some embodiments relates to a disc carrier of a friction clutch, characterized by a subassembly of a modular structure which is composed of interconnectable component parts including a holding ring, at least one web, and a base plate, as well as a hub which is connected to the base plate.

### CROSS-REFERENCE TO RELATED APPLICATIONS

Priority is hereby claimed to European Patent Application No. 07014701.2, filed on Jul. 26, 2007, the entire contents of which are incorporated herein by reference.

### BACKGROUND

The present invention relates to a disc carrier of a friction clutch and to a friction clutch.

The ongoing diversification of model ranges of carmakers on the worldwide car market has spurred the movement toward increasingly smaller numbers of pieces for individual models. In addition, trends continue toward shorter life cycles of models due to regular model revisions. As a result, frequent design changes for subassemblies in the drive trains of vehicles (cars and/or motorcycles) are common, because increasingly greater torques must be transmitted, or weights must be reduced.

In the case of friction clutches in drive trains of vehicles, the casings of conventional prior-art clutch systems are, for example, produced by steel shaping processes, by casting processes or by light-metal die-casting processes. These methods require cost- and time-intensive tooling. When vehicle models are revised, high tooling costs arise in the event of design changes (e.g., smaller or larger diameters or smaller or larger overall lengths).

Particularly with a design of the light-metal casting type, torque transmission to the shaft with the given installation space cannot be realized with light metal. In these cases a hub element of a more rigid material, such as steel, is nowadays cast into the light-metal part. This solution is complicated in terms of its technical process and thus expensive and entails the drawback of thermal stresses in the component due to different coefficients of expansion.

### SUMMARY

It is therefore the object of the present invention to provide a disc carrier of a friction clutch which permits a flexible design that simultaneously provides low tooling costs and ensures fast availability, while being competitive with respect to known disc carriers with regard to component part prices.

According to an embodiment of the present invention, a disc carrier of a modular structure is created in the form of a subassembly of usable component parts that can be assembled in a flexible manner. The component parts can be mounted in different combinations to obtain disc carriers that are usable in many ways. The component parts can be produced for prototypes and in very small quantities by way of suitable methods, for instance laser cutting, in a fast way and at low costs and are thus available. Where greater numbers of pieces are desired, correspondingly advantageous methods can be adopted, for instance punching, without any change in design. By virtue of the multiple-use of the component parts for mounting the disc carrier, low production costs are achieved.

One advantage of the invention over known solutions is the possibility of integrating additional functions, such as torsional dampers in clutches for motorcycles. Production costs and installation space are thereby reduced due to the absence of separate components that assume this function in the conventional design. The construction according to the invention permits the use of materials that allow an increased surface pressure of the discs. The thickness of the discs can thus be reduced, thereby conserving installation space.

The design concept of the friction clutch according to some embodiments of the present invention is ideal for use in motorcycles, but is basically not limited to specific applications and can also be used in any type of vehicle (e.g., also tractors, agricultural machines, construction machines). Furthermore, it is possible according to the present invention to provide both dry and wet multi-disc clutches.

To be more specific, a hub for connection to a gear shaft is provided as a component part. The hub is connected to a base plate, for which purpose different methods, such as shaping processes, thermal joining processes, press connections or also positive connections, are suited. To connect the hub to the gear shaft in a positive way, said hub comprises a hub body with internal teeth that can be brought into engagement with corresponding external teeth of the gear shaft.

The following advantages are achieved according to various embodiments of the present invention over known solutions:
high flexibility in the design of disc carrier variations;
low tooling costs for disc carrier production;
cost savings through multiple use of a component in the same or in different clutches;
cost savings by reducing the number of pieces through omission of components;
distinct reduction of the axial installation space;
low clutch weight in comparison to known clutches;
low mass moment of inertia in comparison to known clutches;
increased bursting speed;
faster prototype availability due to manufacturing processes with small tooling efforts;
improved cooling and lubricating of friction surfaces through more free space for ensuring oil flow;
lower drag moment due to improved oil outflow; and
avoiding any complicated casting-in of hub elements and the resulting thermal stresses.

Further details, advantages, and features of the present invention will become apparent from the following description of embodiments with reference to the drawings.

### BRIEF DESCRIPTION OF THE DRAWINGS

FIG. 1 is a schematically exploded perspective view of a subassembly according to an embodiment of the invention for assembling a disc carrier according to an embodiment of the invention;

FIG. 2 is a perspective view of the mounted disc carrier;

FIG. 3 is a perspective, partial section view of a friction clutch according to an embodiment of the invention; and

FIGS. 4-6 are views of a second preferred embodiment of the disc carrier according to the invention.

### DETAILED DESCRIPTION

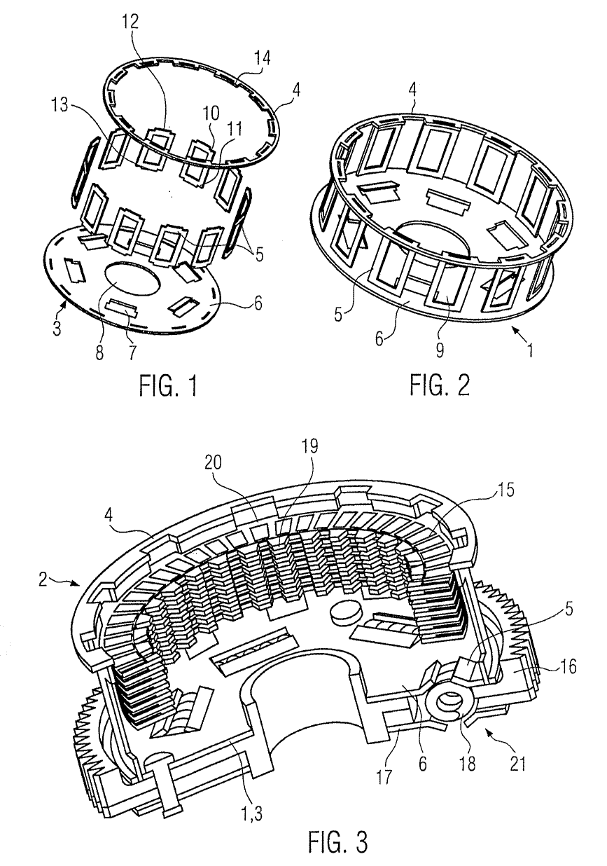

The construction of a disc carrier 1 according to an embodiment of the present invention and of its modular subassembly 3, which is illustrated in FIG. 1 in an exploded view, becomes apparent from a look at both FIG. 1 and FIG. 2. According to FIG. 1 the subassembly 3 includes a circular round holding ring 4 and a base plate 6 in the illustrative example. As shown in FIG. 1, a plurality of webs are arranged between the components 4 and 6 in the illustrative example, all of said webs being of the same construction, and two of said webs being marked in FIG. 1 with reference numeral 5. In the illustrative example, twelve webs are used, each constructed in the form of a frame and rectangle with a rectangular central aperture 9, as shown in detail in FIG. 1.

Tabs 12 and 13 are arranged at the narrow sides 10 and 11 of the respective webs 5, said webs 5 forming a planar flat member in the illustrated embodiment with their tabs. Said tabs 12 and 13 serve to fasten the webs to the holding ring 4 and to the base plate 6, respectively.

The holding ring 4 is configured by way of example and comprises a plurality of inwardly oriented lugs 14. As shown in FIG. 1, the holding ring 4 in the illustrated embodiment comprises twelve lugs 14, the number of lugs corresponding in other words to the number of webs 5 fastened to the lugs 14.

Finally FIG. 1 illustrates, by way of example, the circular construction of the base plate 6, which is provided with a central circular aperture 8 and with a total of six rectangular apertures 7 disposed between the circular aperture 8 and the outer circumference of the base plate 6 and distributed by way of example at equal angular distances. Said rectangular apertures 7 are provided for receiving springs of a torsional damper, which shall be explained in more detail below with reference to FIG. 3.

FIG. 2 illustrates the structure of a disc carrier 1 composed of the subassembly 3. As described above, said carrier comprises twelve webs 5 in the illustrative example, but it is also possible to provide a different number of webs 5, depending on the individual application.

The joining locations between the component parts 4, 5, 6 can be formed for achieving the necessary stiffness and strength of the disc carrier 1 (e.g., by shaping processes, thermal joining processes, adhesive connections or press connections).

FIG. 3 illustrates the friction clutch 2 according to an embodiment of the present invention, which clutch can particularly be used in cars and/or motorcycles.

The friction clutch 2 in the illustrated embodiment is provided with a torsional damper 17, which comprises a plurality of springs, of which FIG. 1 marks a spring with reference numeral 18.

Furthermore, FIG. 3 shows an arrangement of friction discs and complementary discs 19 in the disc carrier 1, of which one friction disc is marked with reference numeral 15, and a lining carrier is marked with reference numeral 20.

In the assembled state of the friction clutch 2 shown in FIG. 3, the base plate 5 can additionally serve as a counter bearing 17 for the springs 18 of the integrated torsional damper 21.

Furthermore, with an appropriate selection of the material for the base plate 6, no special anti-wear measures are needed between springs 18 and base plate 6, as is required in conventional clutches, for instance in motorcycles.

This is also true for the contact region between base plate 6 and primary wheel 16 (also shown in FIG. 3), which in conventional clutches (as in motorcycles, for example) must, as is generally known, include an additional anti-wear component.

With a suitable selection of the material for the webs 5, increased surface pressures are possible between the webs 5 and the friction discs 15, whereby for instance in comparison with clutches in motorcycles the carrier material 20 of the friction lining of the friction discs 15 can be made much thinner and axial installation space can thus be saved to a considerable degree.

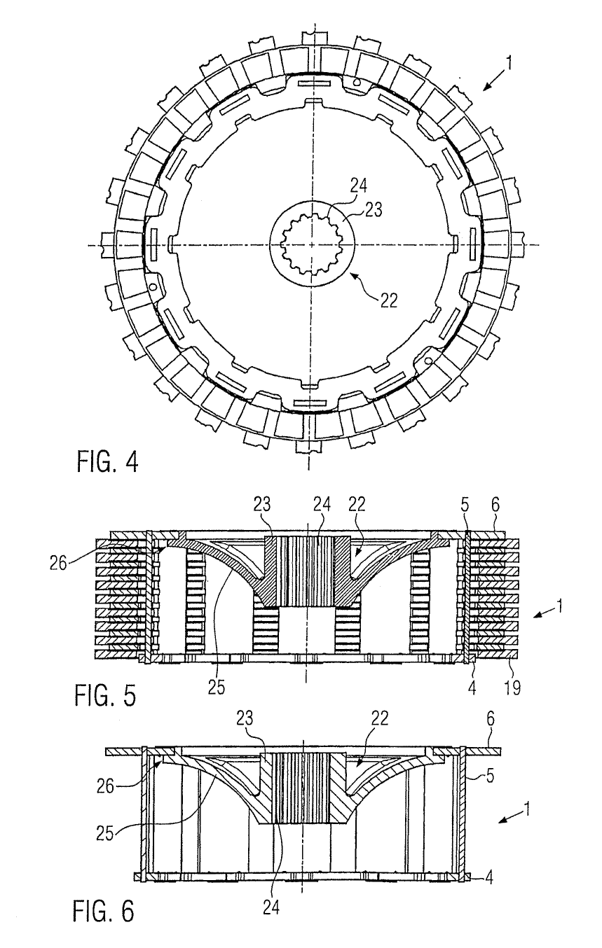

FIGS. 4 to 6 are a top view and sectional views of a second embodiment of the disc carrier 1 according to the invention. The basic parts of said carrier, such as holding ring 4, webs 5, and base plate 6, are configured in the same way as in the embodiment shown in FIGS. 1 to 3. Therefore, as far as these components are concerned, reference can be made to the above description. Moreover, these components are provided with the same reference numerals as in FIGS. 1 to 3.

In addition to the above-explained components of the modular subassembly, the disc carrier 1 according to the embodiment of FIGS. 4 to 6 comprises a hub 22 as a further separate component of subassembly 3, the hub 22 including a cylindrical hub body 23 with internal teeth 24. The hub 22 is connected to the base plate 6. For this purpose it comprises a connecting part 25 which is provided at its free end with a connection area 26 via which the hub 22 is connectable to the base plate 6, for which purpose the joining methods listed by way of example above may be employed.

This embodiment of the disc carrier 1 according to the invention with integrated hub function is particularly suited for vehicles with special demands on high torques and tight package, where suitable materials, such as particularly high-strength metals, for instance steel, may additionally be used for satisfying these demands.

We claim:

1. A disc carrier of a friction clutch, the disc carrier comprising a subassembly of a modular structure which is composed of interconnectable component parts including a holding ring, at least one web, and a base plate, as well as a hub which is connected to the base plate.

2. The disc carrier according to claim 1, wherein all component parts of the modular subassembly are made from the same or different materials which comply with the specific requirements of the component and are connected by way of the same or different joining processes.

3. The disc carrier according to claim 1, wherein the base plate is substantially circular.

4. The disc carrier according to claim 1, wherein the base plate comprises a plurality of apertures.

5. The disc carrier according to claim 1, wherein the web is formed with one or more apertures.

6. The disc carrier according to claim 1, wherein the web is provided at its narrow sides with tabs.

7. The disc carrier according to claim 6, wherein the tabs are bent at the narrow sides.

8. The disc carrier according to claim 1, wherein the holding ring is given one of a circular, annular and polygonal shape.

9. The disc carrier according to claim 1, wherein the holding ring comprises inwardly oriented lugs.

10. The disc carrier according to claim 9, wherein the number of the lugs corresponds to the number of the webs to be mounted.

11. The disc carrier according to claim 1, wherein the component parts are joined by one of a shaping processes, press connections, adhesive connections and by thermal joining.

12. A friction clutch, particularly for cars and/or motorcycles, comprising
a torsional damper; and
a disc carrier including a subassembly of a modular structure which is composed of interconnectable component parts including a holding ring, at least one web, and a base plate, as well as a hub which is connected to the base plate.

13. The disc carrier according to claim 2, wherein the base plate is substantially circular.

14. The disc carrier according to claim 2, wherein the base plate comprises a plurality of apertures.

15. The disc carrier according to claim 3, wherein the base plate comprises a plurality of apertures.

16. The disc carrier according to claim 2, wherein the web is formed with one or more apertures.

17. The disc carrier according to claim 3, wherein the web is formed with one or more apertures.

18. The disc carrier according to claim 4, wherein the web is formed with one or more apertures.

19. The disc carrier according to claim 2, wherein the web is provided at its narrow sides with tabs.

20. The disc carrier according to claim 3, wherein the web is provided at its narrow sides with tabs.
